(19) United States
(12) Patent Application Publication
(10) Pub. No.: US 2006/0089807 A1
(43) Pub. Date: Apr. 27, 2006

(54) Identifying peptide modifications

(75) Inventor: Fernando M Maroto, Santa Clara, CA (US)

Correspondence Address: FISH & RICHARDSON P.C., PO BOX 1022, MINNEAPOLIS, MN, 55440-1022, US

(73) Assignee: Thermo Finnigan, LLC, San Jose, CA (US)

(21) Appl. No.: 10/512,606

(22) PCT Filed: Mar. 11, 2003
(86) PCT No.: PCT/US03/07637

§ 371 Date: Aug. 29, 2005

Related U.S. Application Data
(60) Provisional application No. 60/363,647, filed on Mar. 11, 2002.

(51) Int. Cl. G06F 19/00

(52) U.S. Cl. 702/19

(57) ABSTRACT

Methods, systems and apparatus implement techniques for identifying modifications in polypeptides. A set of candidate sequences is identified that includes sequence information potentially corresponding to an unmodified variant of the polypeptide. Peptides derived from the polypeptide are sequenced to identify sequence tags. The sequence tags are compared with sequence information for the set of candidate sequences to identify a candidate sequence containing the sequence tags. For each such sequence tag, the difference between at least one subsequence mass of the corresponding peptide and at least one subsequence mass of the identified candidate sequence is calculated. The candidate sequences containing the sequence tags can be identified by searching a reduced database constructed based on the identified set of candidate sequences.

### CROSS REFERENCE TO RELATED APPLICATIONS

This application claims the benefit of provisional application No. 60/363,647, filed Mar. 11, 2002, which is incorporated by reference herein.

### BACKGROUND

The present invention relates to proteomics and the identification of modifications in polypeptides.

Tandem mass spectrometry has become the method of choice for fast and efficient identification of proteins in biological samples. In addition, mass spectrometry can be used to sequence peptides de novo. For example, tandem mass spectrometry of peptides generated by proteolytic digestion of a complex protein mixture (e.g., a cell extract) can be used to identify and quantify the proteins present in original mixture. This result can be achieved because tandem mass spectrometers capable of selecting single m/z values and subjecting the ions to collision induced dissociation (CID) can be used to sequence and identify peptides. The information created by CID of a peptide can be used to search peptide and nucleotide sequence databases to identify the amino acid sequence represented by the spectrum and thus identify the protein from which the peptide was derived.

Tandem mass spectrometry produces three types of information that can be used to identify a peptide in a complex mixture of peptides derived from digested proteins. First, the mass of the peptide is obtained. This information alone can greatly reduce number of possible peptide sequences, particularly if the protein was digested with a sequence specific protease. The second type of information is the pattern of fragment ions produced by CID of the peptide ion. Analytical methods that compare the fragment ion pattern to theoretical fragment ion patterns generated computationally from sequence databases can be used to identify the peptide sequence. Such methods can identify the best match peptides and statistically determine which peptide sequence is more likely to be correct. The accuracy of the predictions can be increased further by using multiple stages of MS analysis to obtain de novo the sequence of a portion of a peptide. This direct sequence information can be used to further increase the accuracy of the prediction based on the fragment ion patterns.

Once the peptide is identified, the protein from which it was generated in some cases be determined by searching sequence databases. However, the protein can be identified by a database search only if its sequence has been previously determined, and is present in the database. A database search will fail if the sequence of the protein is not available, or when the peptide contains unexpected modifications.

### SUMMARY

The invention provides computer-implemented techniques for identifying modifications in polypeptides. In general, in one aspect, the invention features methods, systems and apparatus, including computer program products, implementing techniques for identifying a modification in a polypeptide. The techniques include identifying a set of one or more candidate sequences including sequence information potentially corresponding to an unmodified variant of the polypeptide, the unmodified variant being of known sequence; sequencing at least a portion of one or more peptides derived from the polypeptide to identify a sequence tag in a peptide of the one or more peptides; comparing the identified sequence tag with sequence information for the set of candidate sequences to identify a candidate sequence containing the identified sequence tag; and calculating the difference between at least one subsequence mass of the peptide and at least one subsequence mass of the identified candidate sequence.

Particular implementations can include one or more of the following features. Identifying a set of candidate sequences can include identifying a set of candidate peptides that may be present in both the polypeptide and a known, unmodified variant of the polypeptide. Sequencing at least a portion of one or more peptides derived from the polypeptide to identify a sequence tag can include sequencing at least a portion of the one or more peptides based on mass spectrometry data. A modification can be identified in the polypeptide based on the calculated difference in mass.

Identifying a set of candidate sequences can include receiving mass spectra for one or more peptides derived from the polypeptide, and searching a collection of known sequence information based on the mass spectra. Searching a collection of known sequence information based on the mass spectra can include comparing mass spectra of the one or more peptides with mass spectra for amino acid sequences represented in the collection of known sequence information. Searching a collection of known sequence information based on the mass spectra can include identifying amino acid sequences of one or more of the peptides, and comparing the identified amino acid sequences with amino acid sequences represented in the collection of known sequence information. Identifying amino acid sequences of one or more of the peptides can include sequencing at least a fragment of one or more of the peptides to identify an amino acid sequence of the corresponding peptide. The amino acid sequence of the corresponding peptide can include a sequence of six or more amino acids of the corresponding peptide.

Identifying a set of candidate sequences can include constructing a reduced database consisting of sequence information for the identified candidate sequences. Comparing the identified sequence tag with sequence information for the set of candidate sequences can include searching the reduced database based on the identified sequence tag. Sequencing at least a portion of one or more peptides derived from the polypeptide to identify a sequence tag can include identifying a sequence of from two to four amino acids. Calculating the difference between at least one subsequence mass of the peptide and at least one subsequence mass of the identified candidate sequence can include calculating a difference in mass between a tag prefix or tag suffix of the peptide and a corresponding tag prefix or tag suffix of the identified candidate sequence.

The invention can be implemented to realize one or more of the following advantages. Using sequence tags to search a reduced database or collection of candidate sequences makes it possible to identify modifications in unknown polypeptides at a high confidence level. Unknown modifications, which typically cannot be identified using a conventional database search, can be identified with little or no prior knowledge. Any kind of modification can be identified, including mutations, additions, deletions and posttranslational modifications. Using sequence tags to search a reduced database makes it possible to identify modified polypeptides with higher confidence than using just a conventional database search.

The details of one or more embodiments of the invention are set forth in the accompanying drawings and the description below. Unless otherwise defined, all technical and scientific terms used herein have the meaning commonly understood by one of ordinary skill in the art to which this invention belongs. All publications, patent applications, patents, and other references mentioned herein are incorporated by reference in their entirety. In case of conflict, the present specification, including definitions, will control. Other features and advantages of the invention will become apparent from the description, the drawings, and the claims.

### BRIEF DESCRIPTION OF THE DRAWINGS

FIG. 1 is schematic diagram illustrating a system operable to identify modifications in peptides according to one aspect of the invention.

FIG. 2 is a flow diagram illustrating one implementation of a method for identifying modifications in peptides.

FIG. 3A is a schematic diagram illustrating a sequence tag in a peptide.

FIG. 3B illustrates data generated in an exemplary MS² experiment that can be used to identify a sequence tag in a peptide.

FIG. 4 is a schematic diagram illustrating the identification of a sequence tag in a candidate sequence.

FIG. 5 is an exemplary output file from a sequencing module of an analysis program according to one aspect of the invention.

FIG. 6 is a table listing a number of peptides identified in an exemplary experiment, including a number of identified modifications, according to one aspect of the invention.

FIG. 7 shows the peptides identified in the exemplary experiment of FIG. 6, including the identified modifications, in the context of their corresponding proteins.

FIG. 8 illustrates the modifications identified in the exemplary experiment of FIGS. 6 and 7 in more detail.

Like reference numbers and designations in the various drawings indicate like elements.

### DETAILED DESCRIPTION

The invention provides methods and apparatus, including computer program products, for identifying modifications in polypeptides. Sequence information derived from peptide subsequences of an unknown polypeptide is compared with a set of candidate sequences that potentially correspond to unmodified variants of the unknown polypeptide. Modifications can be inferred in unknown regions of the peptide subsequences that lie outside of the derived sequence information.

As used in this specification, a peptide or polypeptide is a polymeric molecule containing two or more amino acids joined by peptide (amide) bonds. As used in this specification, a peptide typically represents a subunit of a parent polypeptide, such as a fragment produced by cleavage or fragmentation of the parent polypeptide using known techniques. Peptides and polypeptides can be naturally occurring (e.g., proteins or fragments thereof) or of synthetic nature. Polypeptides can also consist of a combination of naturally occurring amino acids and artificial amino acids. Peptides and polypeptides can be derived from any source, such as animals (e.g., humans), plants, fungi, bacteria, and/or viruses, and can be obtained from cell samples, tissue samples, bodily fluids, or environmental samples, such as soil, water, and air samples.

Modifications that can be identified using the techniques described herein can be known or unknown protein modifications, including mutations, additions, deletions, and posttranslational modifications, as well as unnatural, chemical modifications, such as chemical tags, fluorescent labels or other covalently bound chemical entities. Modifications can be naturally occurring, such that the modified protein is a naturally occurring protein, or can be artificial. Thus, for example, the techniques described herein can be used to identify a mutation from a known form of a protein, to identify a difference between two homologous proteins, such as related proteins from different species, or to identify a posttranslational acetylation or glycosylation of a protein for which the original amino acid sequence is known.

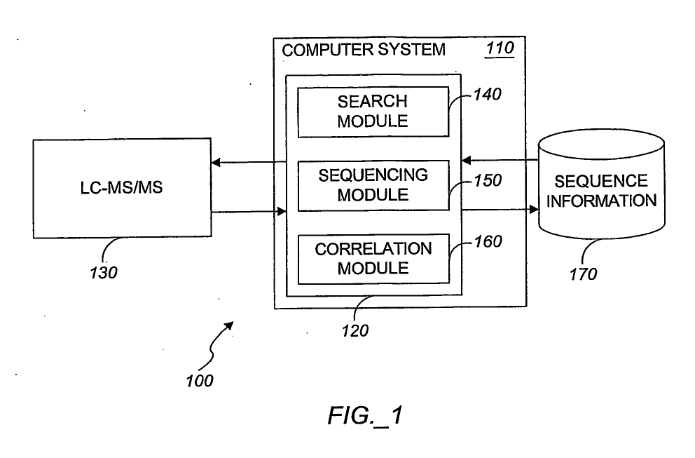

FIG. 1 illustrates one implementation of a system 100 for identifying modifications in peptides according to one aspect of the invention. System 100 includes a general-purpose programmable digital computer system 110 of conventional construction, which can include a memory and one or more processors running an analysis program 120. Computer system 110 has access to a source of mass spectral data 130, which in the embodiment shown is a LC-MS/MS mass spectrometer. Alternatively, the source of mass spectral data 130 can be any mass spectrometer capable of generating CID spectra, such as MALDI-TOF, TOF-TOF, ICR-FT mass spectrometers. Analysis program 120 includes a plurality of computer program modules (some or all of which can alternatively be implemented as separate computer programs), including a search module 140, a sequencing module 150, and a correlation module 160. Computer system 110 is coupled to a source of sequence information 170, such as a public database of amino acid or nucleotide sequence information. System 100 can also include input devices, such as a keyboard and/or mouse, and output devices such as a display monitor, as well as conventional communications hardware and software by which computer system 110 can be connected to other computer systems (or to mass analyzer 130 and/or database 170), such as over a network.

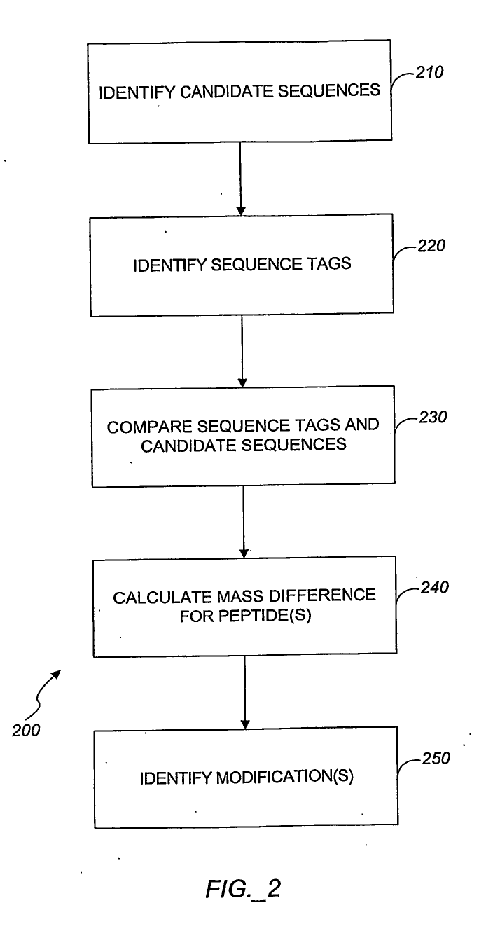

FIG. 2 illustrates a method 200 of identifying one or more modifications in a polypeptide. Some or all of method 200 can be performed using a system 100 as illustrated in FIG. 1. The method begins by identifying a set of candidate sequences that potentially correspond to one or more unmodified variants of an unknown polypeptide (step 210). The set of candidate sequences can be identified using a variety of conventional techniques.

In one implementation, the set of unmodified candidate sequences for an unknown polypeptide is identified based on mass data, such as mass spectra, for a collection of peptides present in both the modified and unmodified variants of the polypeptide. The collection of peptides can include fragments of the polypeptide that are generated by cleavage or fragmentation of the polypeptide or a mixture of polypeptides using known techniques. For example, the collection of peptides can be generated by digestion of a protein or mixture of proteins with well-known reagents, including enzymes or chemicals such as cyanogenbromide using standard techniques. Alternatively, fragments can be generated by ionization or collision-induced dissociation (“CID”) techniques as will be discussed in more detail below.

It is noted that it is common in the field of mass spectrometry to speak in abbreviated fashion in terms of “mass” of ions, although it would be more precise to speak of the mass-to-charge ratio of ions, which is what is really being measured. For convenience, this specification adopts the common practice, and frequently uses the term “mass” to mean mass-to-charge ratios or quantities mathematically derived from those mentioned mass-to-charge ratios.

The set of candidate sequences can be identified by correlating mass spectra for some of its peptides (common to both, the polypeptide and its unmodified variant) with a database containing the known sequence of the unmodified variant of the polypeptide. For example, a set of candidate sequences can be identified by using any commercially available database search engine software such as the TurboSEQUEST® protein identification software, available from Thermo Finnigan of San Jose, Calif., to compare the obtained mass spectra with theoretical mass spectra determined for peptides represented in a database of sequence information, such as a publicly available peptide or nucleotide sequence database. Other database search engines, such as Mascot, ProFound, SpectrumMill, RADARS, Sonar software and the like, can also be used. The database itself can be any publicly available database of sequence information, such as the GenBank/GenPept, PIR, SWISS-PROT and PDB databases. The set of candidate sequences can be defined as the set of polypeptides that include peptides for which the score exceeds a pre-determined or user-defined threshold.

In another implementation, the set of candidate sequences can be identified by partial or complete sequencing of the peptides in the collection of peptides using de novo sequencing techniques, followed by localization of the resulting sequence tags in a publicly available database. In de novo sequencing, the amino acid sequence of a polypeptide is determined by fragmenting the polypeptide along the peptide backbone using techniques such as ionization or CID, and subjecting the fragments to mass analysis. This can be done using tandem (e.g., MS² or higher order MSⁿ) mass spectrometry to select a parent ion for the polypeptide in question and subject the selected ion to fragmentation. Differences in mass between the resulting peptide fragments (i.e., fragment ions) correspond to the mass of one or more amino acids lost in the fragmentation process. Depending on the quality of the data, partial or complete sequence information for the parent polypeptide can thus be deduced from the relative positions of signals in the fragment spectra. CID spectra are particularly useful for identifying and locating peptide modifications, potentially providing information to both indicate the presence of such modifications and to pinpoint the exact amino acid that is chemically or biologically modified, as will be discussed in more detail below.

The sequence information derived from de novo sequencing can be used to search for similar or matching sequences in or derived from publicly available sequence databases—for example, using conventional sequence similarity search techniques such as BLAST (Basic Local Alignment Search Tool) or MS-BLAST, which was specifically developed to identify de novo sequencing output in the database—to identify the set of candidate sequences. The number of amino acids required to identify a sequence in a database will vary depending on the nature and size of the database. For example, a sequence of at least six or seven amino acids is typically required to identify a protein in a database of human proteins. The result of the de novo sequencing can include a list of peptides (e.g., amino acid sequences) that could be responsible for a given mass spectrum, and closeness-of-fit or correlation scores or probabilities associated with each amino acid sequence representing the likelihood of a match with the mass spectrum. The set of candidate sequences can be defined as the set of polypeptides that include peptides identified de novo. In either of these implementations, any unknown modifications must occur in the unmatched spectra, for which no candidate sequence is identified.

Alternatively, the set of candidate sequences can be identified using other protein identification techniques, such as gel electrophoresis. Where the unmodified variant of the unknown polypeptide is known, the set of candidate sequences can be identified based on direct input from the operator. The range of possible sequence candidates can also be narrowed through prior knowledge of the source of the sample, the sample history or other related components known to be present in the sample.

In one implementation, the set of candidate sequences is used to populate a reduced database of candidate sequence information that will be used in subsequent processing, as described in more detail below. The database of candidate sequence information can be a subset of a larger nucleotide or peptide sequence database, such as the publicly available databases identified above. Thus, for example, nucleotide or amino acid sequences corresponding to the known polypeptides identified in step 210 as potentially corresponding to the unknown polypeptide can be loaded into a searchable database using conventional techniques.

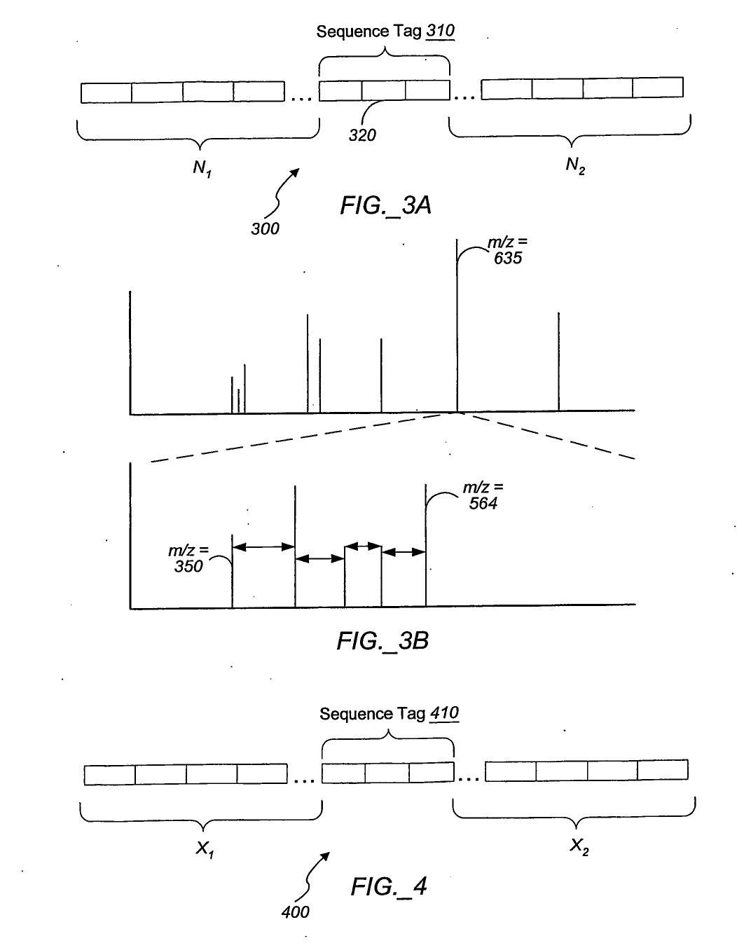

De novo sequencing information for one or more peptides derived from the polypeptide is used to identify one or more sequence tags (step 220). As illustrated in FIG. 3A, a sequence tag 310 consists of a sequence of two or more amino acid residues 320 identified for a given peptide 300. A sequence tag will represent a partial sequence of the corresponding peptide (i.e., a sequence of one or more amino acids), and a prefix N₁ and a suffix N₂. The prefix N₁ is the mass of that portion (modified or not) of the corresponding peptide that precedes the partial sequence of the tag (corresponding to, for example, the mass of the subsequence responsible for the ion of m/z=350 derived from the parent ion of m/z=635 in a MS² experiment in which the sequence tag 310 is identified as illustrated in FIG. 3B). The calculation of such a mass involves the mass of the ion and can involve the mass of the precursor ion and other product ions. Similarly, the suffix N₂ represents the mass of that subsequence of the corresponding peptide that follows the sequence tag (e.g., the subsequence mass derived from the ion of m/z=564 in the experiment illustrated in FIG. 3B).

In implementations using the database search approach described above to identify the set of candidate sequences in step 210 above (or implementations using other, non-MS based techniques for identifying the set of candidate sequences), the sequence tags can be identified by performing de novo sequencing automatically or manually on one or more of the unmatched spectra. In one implementation, de novo sequencing can be performed using DeNovoX automatic de novo sequencing software, available from Thermo Finnigan of San Jose, Calif. Multiple tags can be identified in some or all of the peptides. The sequence tags are compared with the set of candidate sequences to identify the modified polypeptide or polypeptides (i.e., the known polypeptide or polypeptides that represents the unmodified variant of the unknown polypeptide) (step 230). For example, a reduced database of sequences corresponding to the set of candidate sequences can be searched to identify candidate peptides that include one or more identified sequence tags. The set of candidate sequences can be searched using publicly available software programs, such as BLAST, which output a list of potentially matching sequences and associated scores indicating the quality of the match. A given sequence tag can be reversed in a given peptide (i.e., the tag can appear in its corresponding peptide in reverse of the order it occurs in the corresponding candidate sequence). In some implementations, the correlation module can be configured to account for such differences, and for minor errors in the mass data.

The subsequence of a tag can be localized into a candidate sequence corresponding to a potential unmodified variant of the polypeptide. MS BLAST or other database search techniques can be used to localize the tag subsequence in the candidate sequences, and can be configured to take into account differences between the tag sequence and a “matching” candidate sequence, which may result, for example, from minor errors in the mass data. This yields a possible location for an unmatched peptide in the potentially corresponding candidate sequence.

Once the set of candidate sequences is identified (e.g., once a reduced database of candidate sequence information has been constructed), a tag of three or four amino acids will typically be sufficient to identify the corresponding modified peptide with high confidence. Even if the sample is not of high quality, tags of this length (and often much longer) can usually be identified using de novo sequencing. The probability to have a correct identification for a given sequence tag (i.e., the confidence level of a match between a sequence tag and a candidate sequence) is given by the formula:
p=(1−(1/A)^{L}×2^{p})^{N×S}
where A is the number of the non-modified amino acids (i.e., typically 20, representing the number of naturally-occurring amino acids), L is the length in amino acids of the sequence tag, S is the length in amino acids of the set of candidate sequences, p is the number of amino acids on the tag with an isobaric pair (e.g., L or I), and N is the total number of tags to be correlated. Note that this equation does not apply if the de novo sequencing information does not match the candidate sequence information in the database exactly, or if the identification of one tag is not carried out independent of the other tags, although the techniques described herein can still be used.

For each sequence tag, the mass differences between the peptide and a corresponding subsequence of the candidate sequence are calculated (step 240). Referring to FIG. 4, a prefix sequence mass X₁ and a suffix sequence mass X₂ are calculated for the candidate sequence 400. The prefix sequence mass represents the mass of a subsequence of the candidate sequence that precedes the tag location, while the suffix sequence mass represents the mass of a subsequence of the candidate sequence that follows the tag location. The prefix and suffix sequence masses for the candidate sequence can be calculated by adding amino acid masses for the relevant subsequence of the candidate sequence.

A prefix mass difference Δm₁=N₁−X₁ is calculated by subtracting the mass of the tag prefix N₁ from the candidate sequence prefix sequence mass X₁; a suffix mass difference Δm₂=N₂−X₂ is similarly calculated by subtracting the mass of the tag suffix N₂ from the candidate sequence suffix sequence mass X₂.

The mass difference can be used to infer that a modification is present in the corresponding peptide (step 250). Assuming correct identification of the prefix and suffix portions of the candidate sequence, a mass difference of zero (or almost zero depending on the accuracy of the mass data) indicates that no modification is present in the relevant peptide subsequence. Where Δm₁ or Δm₂ is non-zero, the mass difference represents the mass of one or more modifications to the peptide subsequence. In some implementations, the analysis program outputs to the user the known sequence (i.e., the relevant portion of the candidate sequence) and the corresponding mass difference. Alternatively, or in addition, the non-zero mass difference(s) can be used to identify the actual chemical modification or modifications present in the peptide, by searching in a collection of known amino acid modifications (e.g., a publicly available database of such modifications) constrained to the amino acids present in the prefix or suffix to identify a modification that could be responsible for the mass difference.

Thus, application of the techniques described above provide for the identification of the modified peptide with high confidence, the deduction of the mass of the modification, the localization of the modification within the prefix subsequence or suffix subsequence, and the deduction of the prefix subsequence and suffix subsequence.

Aspects of the invention can be implemented in digital electronic circuitry, or in computer hardware, firmware, software, or in combinations of them. Some or all aspects of the invention can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Some or all of the method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). The methods of the invention can be implemented as a combination of steps performed automatically, under computer control, and steps performed manually by a human user, such as a scientist.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well.

The invention will be further described in the following example, which is illustrative only, and which is not intended to limit the scope of the invention described in the claims.

### EXAMPLE

A mixture of bovine ubiquitin, bovine serum albumin (“BSA”) and bovine carbonic anhydrase (CA II), all obtained from Sigma-Aldrich, St. Louis, Mo., USA was prepared. The protein mixture was reduced with dithiothreitol, carboxyamidomethylated with iodoacetamide, and digested with trypsin, all using conventional protein biochemistry techniques. LC/MS/MS spectra were collected using an LCQ DECA™ ion trap mass spectrometer in tandem with an HPLC Surveyor™ system, both of which are available from Thermo Finnigan of San Jose, Calif. All of the acquired spectra were analyzed using the PARSEK II program in unattended batch sequencing mode, initially with default parameters, and subsequently specifying the carboxyamidomethylation with lower tolerance threshold. The output from the sequencing module of the analysis program was manually correlated with the whole database, without any conventional database search.

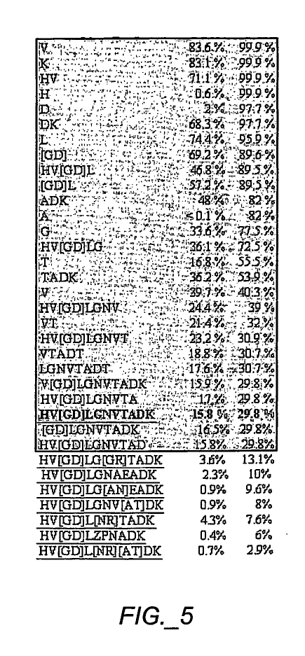

An exemplary output file from the sequencing module of the analysis program is illustrated in FIG. 5. Absolute and relative probabilities for each tag are shown on the right. The complete sequences are underlined; the correct subsequences and tags are shown in the box. To utilize this information effectively, additional information—namely, the prefix and suffix mass information, is required.

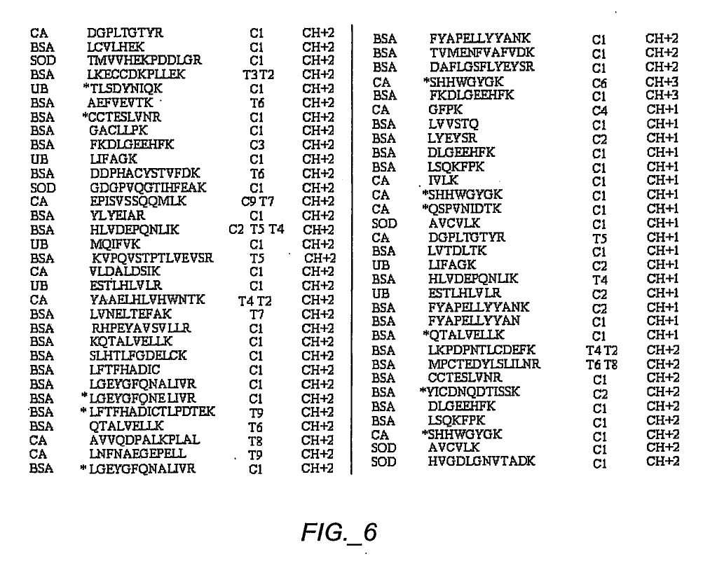

A total of 65 peptides were identified (more than using a conventional database search). All were identified unambiguously after correlation with a bovine database. Sixty-three of the identified peptides are listed in FIG. 6. An additional two peptides from the trypsin were identified. In FIG. 6, CN stands for complete sequence found in position N on the program output (i.e., Cl means sequence found as first choice); TN means highest probability tag of N amino acids. Modified peptides are identified with a “*”.

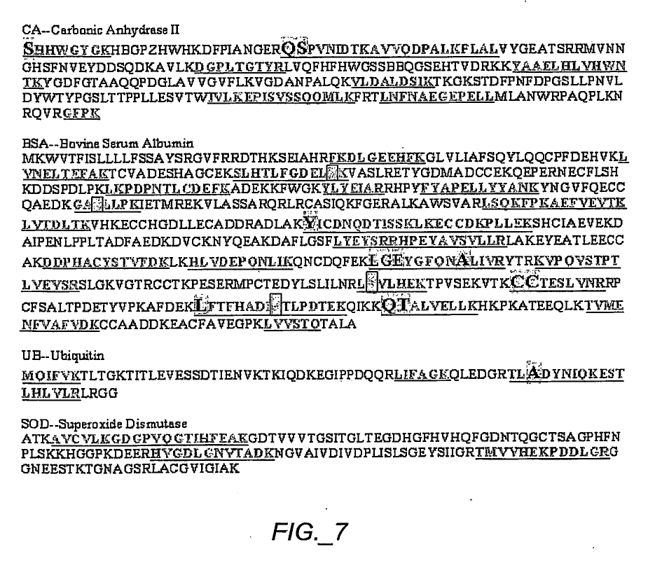

The identified peptides are shown in context in FIG. 7. The underlined coverage was obtained with the identified peptides using only de novo sequencing (i.e., no previous database search was done). The modifications identified by correlating the de novo sequencing output with known sequences of the proteins are shown highlighted in bold. Four artificially introduced modifications (carboxyamidomethylations, represented by boxes) were identified de novo, even when the modification was not known by the de novo sequencing software.

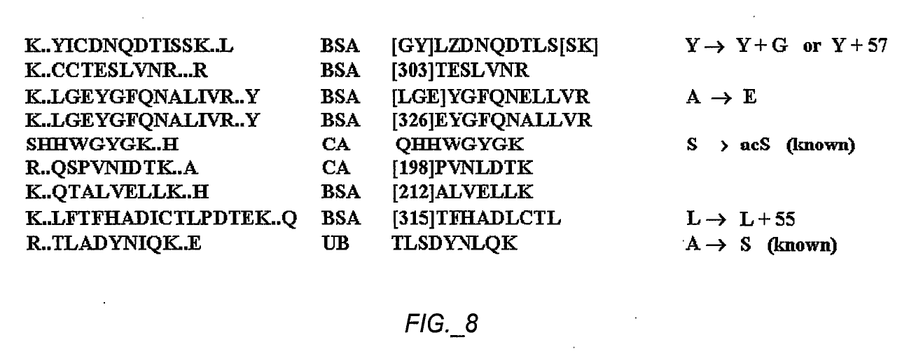

Nine modifications were found in just four well-known proteins, as illustrated in FIG. 8. All were identified unambiguously. As illustrated, the acetylated serine was found in the three different charge states. The peptide LGEYGFQNALIVR appears in three forms: non-modified and modified in two different ways. There is a possible unknown mutation A to E on BSA. In four of the cases the modification is localized at one of two or three amino acids, although the locations of the modification cannot be determined more precisely. It is believed that of all of the identified modifications, only the acetylation and the modification on the ubiquitin were previously reported.

The carboxyamidomethylation was inferred from multiple files even when this information was not disclosed to the operators. An additional two proteins were found de novo: superoxide dismutase and bovine trypsinogen, both contaminants.

The invention has been described in terms of particular embodiments. Other embodiments are within the scope of the following claims. For example, the steps of the invention can be performed in a different order and still achieve desirable results.

What is claimed is:

1. A method of identifying a modification in a polypeptide, comprising:
identifying a set of one or more candidate sequences including sequence information potentially corresponding to an unmodified variant of the polypeptide, the unmodified variant being of known sequence;
sequencing at least a portion of one or more peptides derived from the polypeptide to identify a sequence tag in a peptide of the one or more peptides;
comparing the identified sequence tag with sequence information for the set of candidate sequences to identify a candidate sequence containing the identified sequence tag; and
calculating the difference between at least one subsequence mass of the peptide and at least one subsequence mass of the identified candidate sequence.

2. The method of claim 1, wherein:
identifying a set of candidate sequences includes identifying a set of candidate peptides that may be present in both the polypeptide and a known, unmodified variant of the polypeptide.

3. The method of claim 1, wherein:
sequencing at least a portion of one or more peptides derived from the polypeptide to identify a sequence tag includes sequencing at least a portion of the one or more peptides based on mass spectrometry data.

4. The method of claim 1, further comprising:
identifying a modification in the polypeptide based on the calculated difference in mass.

5. The method of claim 1, wherein identifying a set of candidate sequences comprises:
receiving mass spectra for one or more peptides derived from the polypeptide; and
searching a collection of known sequence information based on the mass spectra.

6. The method of claim 5, wherein searching a collection of known sequence information based on the mass spectra comprises:
comparing mass spectra of the one or more peptides with mass spectra for amino acid sequences represented in the collection of known sequence information.

7. The method of claim 5, wherein searching a collection of known sequence information based on the mass spectra comprises:
identifying amino acid sequences of one or more of the peptides; and
comparing the identified amino acid sequences with amino acid sequences represented in the collection of known sequence information.

8. The method of claim 7, wherein:
identifying amino acid sequences of one or more of the peptides includes sequencing at least a fragment of one or more of the peptides to identify an amino acid sequence of the corresponding peptide.

9. The method of claim 8, wherein:
the amino acid sequence of the corresponding peptide includes a sequence of six or more amino acids of the corresponding peptide.

10. The method of claim 5, wherein:
identifying a set of candidate sequences includes constructing a reduced database consisting of sequence information for the identified candidate sequences; and
comparing the identified sequence tag with sequence information for the set of candidate sequences includes searching the reduced database based on the identified sequence tag.

11. The method of claim 1, wherein:
sequencing at least a portion of one or more peptides derived from the polypeptide to identify a sequence tag includes identifying a sequence of from two to four amino acids.

12. The method of claim 1, wherein:
calculating the difference between at least one subsequence mass of the peptide and at least one subsequence mass of the identified candidate sequence includes calculating a difference in mass between a tag prefix or tag suffix of the peptide and a corresponding tag prefix or tag suffix of the identified candidate sequence.

13. A computer program product on a computer-readable medium for identifying a modification in a polypeptide, the product comprising instructions operable to cause a programmable processor to:
identify a set of one or more candidate sequences including sequence information potentially corresponding to an unmodified variant of the polypeptide, the unmodified variant being of known sequence;
sequence at least a portion of one or more peptides derived from the polypeptide to identify a sequence tag in a peptide of the one or more peptides;
compare the identified sequence tag with sequence information for the set of candidate sequences to identify a candidate sequence containing the identified sequence tag; and
calculate the difference between at least one subsequence mass of the peptide and at least one subsequence mass of the identified candidate sequence.

14 The computer program product of claim 13, wherein:
the instructions operable to cause a programmable processor to identify a set of candidate sequences include instructions operable to cause a programmable processor to identify a set of candidate peptides that may be present in both the polypeptide and a known, unmodified variant of the polypeptide.

15. The computer program product of claim 13, wherein:
the instructions operable to cause a programmable processor to sequence at least a portion of one or more peptides derived from the polypeptide to identify a sequence tag include instructions operable to cause a programmable processor to sequence at least a portion of the one or more peptides based on mass spectrometry data.

16. The computer program product of claim 13, further comprising instructions operable to cause a programmable processor to:
identify a modification in the polypeptide based on the calculated difference in mass.

17. The computer program product of claim 13, wherein the instructions operable to cause a programmable processor to identify a set of candidate sequences comprise instructions operable to cause a programmable processor to:
receive mass spectra for one or more peptides derived from the polypeptide; and
search a collection of known sequence information based on the mass spectra.

18. The computer program product of claim 17, wherein:
the instructions operable to cause a programmable processor to search a collection of known sequence information based on the mass spectra include instructions operable to cause a programmable processor to compare mass spectra of the one or more peptides with mass spectra for amino acid sequences represented in the collection of known sequence information.

19. The computer program product of claim 17, wherein the instructions operable to cause a programmable processor to searching a collection of known sequence information based on the mass spectra comprise instructions operable to cause a programmable processor to:
identify amino acid sequences of one or more of the peptides; and
compare the identified amino acid sequences with amino acid sequences represented in the collection of known sequence information.

20. The computer program product of claim 19, wherein:
the instructions operable to cause a programmable processor to identify amino acid sequences of one or more of the peptides include instructions operable to cause a programmable processor to sequence at least a fragment of one or more of the peptides to identify an amino acid sequence of the corresponding peptide.

21. The computer program product of claim 20, wherein:
the amino acid sequence of the corresponding peptide includes a sequence of six or more amino acids of the corresponding peptide.

22. The computer program product of claim 17, wherein:
the instructions operable to cause a programmable processor to identify a set of candidate sequences include instructions operable to cause a programmable processor to construct a reduced database consisting of sequence information for the identified candidate sequences; and
the instructions operable to cause a programmable processor to compare the identified sequence tag with sequence information for the set of candidate sequences include instructions operable to cause a programmable processor to search the reduced database based on the identified sequence tag.

23. The computer program product of claim 13, wherein:
the instructions operable to cause a programmable processor to sequence at least a portion of one or more peptides derived from the polypeptide to identify a sequence tag include instructions operable to cause a programmable processor to identify a sequence of from two to four amino acids.

24. The computer program product of claim 13, wherein:
the instructions operable to cause a programmable processor to calculate the difference between at least one subsequence mass of the peptide and at least one subsequence mass of the identified candidate sequence include instructions operable to cause a programmable processor to calculate a difference in mass between a tag prefix or tag suffix of the peptide and a corresponding tag prefix or tag suffix of the identified candidate sequence.

25. A system for identifying a modification in a polypeptide, comprising:
means for identifying a set of one or more candidate sequences including sequence information potentially corresponding to an unmodified variant of the polypeptide, the unmodified variant being of known sequence;
means for sequencing at least a portion of one or more peptides derived from the polypeptide to identify a sequence tag in a peptide of the one or more peptides;
means for comparing the identified sequence tag with sequence information for the set of candidate sequences to identify a candidate sequence containing the identified sequence tag; and
means for calculating the difference between at least one subsequence mass of the peptide and at least one subsequence mass of the identified candidate sequence.
